(19) United States
(12) Patent Application Publication
(10) Pub. No.: US 2017/0006296 A1
(43) Pub. Date: Jan. 5, 2017

(54) METHOD AND DEVICE FOR DERIVING MOTION INFORMATION USING DEPTH INFORMATION, AND METHOD AND DEVICE FOR DERIVING MOTION MERGING CANDIDATE USING DEPTH INFORMATION

(71) Applicant: INTELLECTUAL DISCOVERY CO., LTD., Seoul (KR)

(72) Inventors: Gwang Hoon PARK, Seongnam-si (KR); Young Su HEO, Suwon-si (KR); Min Seong LEE, Pyeongtaek-si (KR); Yoon Jin LEE, Yongin-si (KR)

(73) Assignee: INTELLECTUAL DISCOVERY CO., LTD., Seoul (KR)

(21) Appl. No.: 15/125,874

(22) PCT Filed: Jan. 19, 2015
(86) PCT No.: PCT/KR2015/000509

§ 371 Date: Sep. 13, 2016

(30) Foreign Application Priority Data
Mar. 31, 2014 (KR) 10-2014-0038099

(51) Int. Cl. H04N 19/176; H04N 19/51

(52) U.S. Cl. CPC H04N 19/176; H04N 19/51

(57) ABSTRACT

The present invention provides a method for deriving motion information and a device for encoding an image using depth information. A method for deriving motion information using depth information, according to an embodiment of the present invention, comprises the steps of: comparing each motion information item of a plurality of adjacent blocks that are spatially adjacent to an encoded current block and thereby searching for an adjacent block having the same motion information; comparing, using depth information, whether or not a first object area comprising a block in a reference image temporally corresponding to the current block and a second object area comprising the adjacent block that has been found are the same; and, if the first object area and the second object area are the same, deriving motion information of the adjacent block that has been found as motion information of the current block.

### TECHNICAL FIELD

An embodiment of the present invention relates, in general, to video processing technology and, more particularly, to a method and device for deriving motion information using depth information and a method for deriving a motion merge candidate using depth information.

### BACKGROUND ART

Recently, with the demand for video service having a high-quality video mode such as Full High Definition (FHD) or Ultra High Definition (UHD), the requirement for next-generation video coding standards has increased. The International Organization for Standardization (ISO)/International Electrotechnical Commission (IEC) Moving Picture Experts Group (MPEG) and the Telecommunication Standardization Sector of the International Telecommunications Union (ITU-T) Video Coding Experts Group (VCEG) organized a Joint Collaborative Team on Video Coding (JCT-VC), and worked on the High Efficiency Video Coding (HEVC) standard as a new video coding standard with the aim of doubling the coding efficiency of H.264/AVC. The development of standard technology for HEVC version 1 was completed in January 2013, and since then, HEVC Range Extension standards for supporting various color formats and bit depths have been under development.

HEVC employs various techniques in consideration not only of encoding efficiency but also of various encoding/decoding procedures required in next-generation video standards. For example, there is technology such as a tile, which is a new unit for partitioning a picture in consideration of the parallelism of encoding/decoding processes, and a Merge Estimation Region (MER) for ensuring the parallelism of decoding based on Prediction Units (PU). Particularly, in response to market demand for high definition and high quality, HEVC employs techniques such as a deblocking filter, a Sample Adaptive Offset (SAO), and a scaling list in order to improve subjective image quality.

However, because a decrease in encoding/decoding efficiency and an increase in memory usage complexity may result when motion information is derived, it is necessary to solve these problems.

Meanwhile, Korean Patent No. 10-1204026, titled “Methods of derivation of temporal motion vector predictor and apparatuses for using the same” discloses a method and apparatus for determining whether a block to be predicted is in contact with the boundary of a largest coding unit (LCU) and determining whether a first call block is available according to whether the block to be predicted is in contact with the boundary of the LCU.

### DISCLOSURE

### Technical Problem

Because hardware capable of generating depth information may be decreased in size and highly integrated in the near future, an object of some embodiments of the present invention is to propose a method and device for more effectively deriving motion information and a motion merge candidate using an acquired depth information image.

However, the technical object intended to be accomplished by the present embodiments is not limited to the above-described technical object, and other technical objects may be present.

### Technical Solution

As a technical solution for accomplishing the above object, a video coding device according to an embodiment of the present invention includes a search unit for searching multiple neighboring blocks for a neighboring block having the same motion information as an encoded current block by comparing motion information of the multiple neighboring blocks, which are spatially adjacent to the current block; a comparison unit for comparing a first object area, including a block within a reference image, which is temporally co-located with the current block, with a second object area, including the found neighboring block, using depth information in order to determine whether the first object area is identical to the second object area; and a derivation unit for deriving the motion information of the found neighboring block as motion information for the current block when the first object area is identical to the second object area.

Also, a video coding device according to another embodiment of the present invention includes a determination unit for determining whether there is motion information for a candidate neighboring block, configured as a motion merge candidate for a current block, among neighboring blocks, which are spatially adjacent to the current block; a comparison unit for comparing a first object area, including a block within a reference image, which is temporally co-located with the current block, with a second object area, including the candidate neighboring block, using depth information in order to determine whether the first object area is identical to the second object area when the motion information for the candidate neighboring block is not present; and a derivation unit for deriving motion information of the block within the reference image as the motion information for the candidate neighboring block when the first object area is identical to the second object area.

Also, a method for deriving motion information using depth information according to an embodiment of the present invention includes searching multiple neighboring blocks for a neighboring block having the same motion information as an encoded current block by comparing motion information of the multiple neighboring blocks, which are spatially adjacent to the current block; comparing a first object area, including a block within a reference image, which is temporally co-located with the current block, with a second object area, including the found neighboring block, using the depth information in order to determine whether the first object area is identical to the second object area; and when the first object area is identical to the second object area, deriving the motion information of the found neighboring block as motion information for the current block.

Also, a method for deriving motion information using depth information according to another embodiment of the present invention includes determining whether there is motion information for a candidate neighboring block, configured as a motion merge candidate for a current block, among neighboring blocks, which are spatially adjacent to the current block; when motion information for the candidate neighboring block is not present, comparing a first object area, including a block within a reference image, which is temporally co-located with the current block, with a second object area, including the candidate neighboring block, using the depth information in order to determine whether the first object area is identical to the second object area; and when the first object area is identical to the second object area, deriving motion information of the block within the reference image as the motion information for the candidate neighboring block.

Also, a method for deriving a motion merge candidate using depth information according to an embodiment of the present invention includes determining whether there is motion information for a candidate neighboring block, configured as a motion merge candidate for a current block, among neighboring blocks, which are spatially adjacent to the current block; when motion information for the candidate neighboring block is not present, comparing a first object area, including a block within a reference image, which is temporally co-located with the current block, with a second object area, including the candidate neighboring block, using the depth information in order to determine whether the first object area is identical to the second object area; when the first object area is identical to the second object area, deriving motion information of the block within the reference image as the motion information for the candidate neighboring block; and deciding whether to include the motion information for the candidate neighboring block in the motion merge candidate for the current block according to a predetermined priority of the candidate neighboring block.

### Advantageous Effects

According to the above-mentioned technical solution of the present invention, 2D video is encoded and decoded using a depth information image acquired from a depth information camera, whereby encoding efficiency for the 2D video may be improved.

Also, when a motion merge candidate is configured using object information in the HEVC motion information derivation algorithm, because the motion merge candidate may be derived through the minimum number of processes by comparing the object information, it is easy to implement the invention.

Also, because the present invention is based on object information, it is very useful for video codecs in which depth information is used, such as 3-dimensional video codecs. Also, because it may be applied not only to 3-dimensional codecs but also to video codecs in which object information is used, it may be applied to various video encoding/decoding procedures.

Also, even if a depth information image is not directly encoded and then transmitted, the depth information image or distance information may be indirectly reconstructed based on whether it is included in the same object area.

### DESCRIPTION OF DRAWINGS

FIG. 1 is an overall block diagram illustrating a video decoder according to an embodiment of the present invention;

FIG. 2 is a block diagram of a video coding device according to an embodiment of the present invention;

FIG. 3 is a block diagram of a video coding device according to another embodiment of the present invention;

FIG. 4 is a flowchart of a method for deriving motion information using depth information according to an embodiment of the present invention;

FIG. 5 illustrates a method for deriving motion information using depth information according to an embodiment of the present invention;

FIG. 6 is a flowchart of a method for deriving motion information using depth information according to another embodiment of the present invention;

FIG. 7 illustrates a method for deriving motion information using depth information according to another embodiment of the present invention; and

FIG. 8 is a flowchart of a method for deriving a motion merge candidate using depth information according to an embodiment of the present invention.

### BEST MODE

Embodiments of the present invention are described with reference to the accompanying drawings in order to describe the present invention in detail so that those having ordinary knowledge in the technical field to which the present invention pertains can easily practice the present invention. However, the present invention may be implemented in various forms, and is not limited by the following embodiments. In the drawings, the illustration of components that are not directly related to the present invention will be omitted, for clear description of the present invention, and the same reference numerals are used to designate the same or similar elements throughout the drawings.

Further, throughout the entire specification, it should be understood that a representation indicating that a first component is “connected” to a second component may include the case where the first component is electrically connected to the second component with some other component interposed therebetween, as well as the case where the first component is “directly connected” to the second component. Furthermore, it should be understood that a representation indicating that a first component “includes” a second component means that other components may be further included, without excluding the possibility that other components will be added, unless a description to the contrary is specifically pointed out in context.

Detailed embodiments of the present invention will be described in detail with reference to the attached drawings. However, the spirit of the present invention is not limited to the presented embodiments, and other embodiments may be easily devised via the addition, modification, deletion or insertion of components within the scope of the same spirit as that of the present invention, and it may be understood that the other embodiments may also be included in the scope of the present invention.

Throughout the present specification, a representation indicating that a first component “includes” a second component means that other components may be further included, without excluding the possibility that other components will be added, unless a description to the contrary is specifically pointed out in context. The term “step of performing -” or “step of-” used throughout the present specification does not mean “step for -”.

Hereinafter, a preferred embodiment of the present invention will be described in detail with reference to the accompanying drawings.

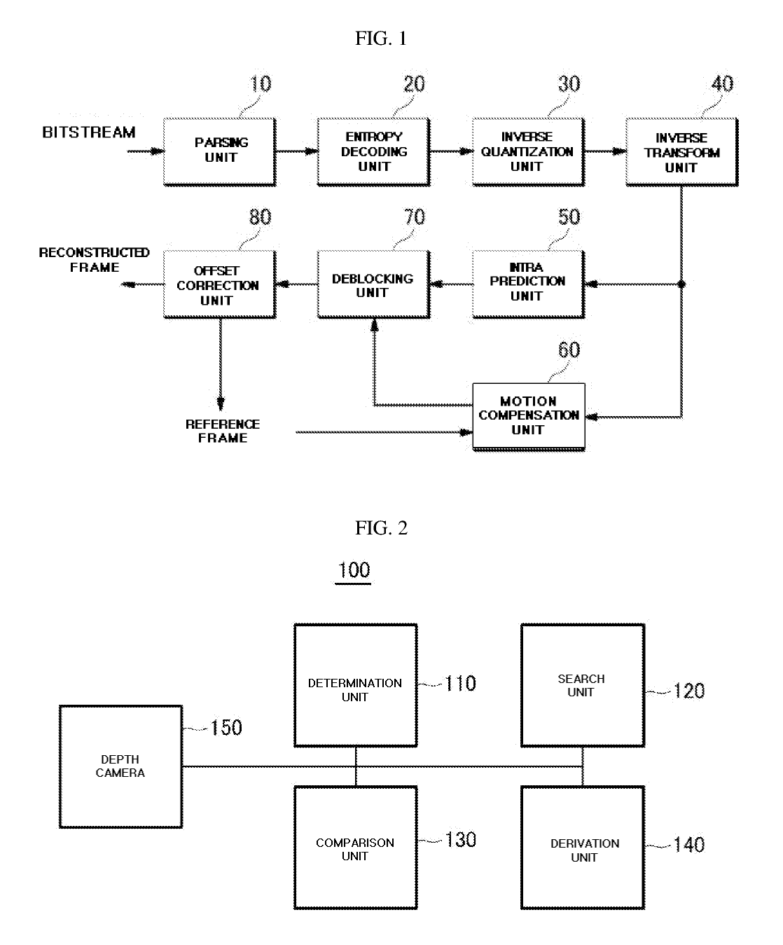

FIG. 1 is an overall block diagram illustrating a video decoder according to an embodiment of the present invention.

For reference, FIG. 1 illustrates a video decoder, but all of the methods and devices disclosed in the embodiments of the present invention may be applied both to encoding and decoding procedures performed in a video processing procedure, and the term ‘coding’ used throughout the present specification is a higher concept including both encoding and decoding procedures. Additionally, because a video encoding procedure and a video decoding procedure correspond to each other in many aspects, those skilled in the art may easily understand an encoding procedure with reference to the description of a decoding procedure, and vice versa.

Referring to FIG. 1, a video decoder according to an embodiment of the present invention includes a parsing unit 10 for receiving and parsing a bitstream and outputting various kinds of information that is necessary for decoding encoded video data. Also, the encoded video data are output as inversely quantized data through an entropy decoding unit 20 and an inverse quantization unit 30, and are then reconstructed into video data in a spatial domain through an inverse transform unit 40. An intra prediction unit 50 performs intra prediction on the video data in a spatial domain by coding units of an intra mode, and a motion compensation unit 60 performs motion compensation using a reference frame by coding units of an inter mode. The data in a spatial domain, which pass through the intra prediction unit 50 and the motion compensation unit 60, are post-processed through a deblocking unit 70 and an offset correction unit 80, and are then output as a reconstructed frame. Also, the post-processed data, which have passed through the deblocking unit 70 and the offset correction unit 80, may be output as a reference frame. This video decoding algorithm corresponds to a conventional art, and a detailed description thereabout will be omitted.

FIG. 2 is a block diagram of a video coding device according to an embodiment of the present invention.

Referring to FIG. 2, a video coding device 100 according to an embodiment of the present invention may include a determination unit 110, a search unit 120, a comparison unit 130, and a derivation unit 140.

The video coding device 100 according to an embodiment of the present invention may be a video encoding/decoding device, and if it is a video decoding device, it may include the components illustrated in FIG. 1.

The determination unit 110 may determine whether motion information for an encoded current block is present.

For example, when the current block is encoded through intra prediction, the determination unit 110 may determine that motion information for the current block is not present.

When motion information for the current block is not present, the search unit 120 may search multiple neighboring blocks, which are spatially adjacent to the current block, for a neighboring block that has the same motion information as the current block by comparing the motion information of the multiple neighboring blocks.

The comparison unit 130 may compare a first object area, including a block within a reference image, which is temporally co-located with the current block, with a second object area, including the found neighboring block, using depth information, in order to determine whether the two object areas are the same.

A depth camera 150 for acquiring the depth information may be combined with or connected to the video coding device 100 as part of the same device, or may be arranged as a separate device. Also, with technological advances, it may be variously manufactured without limitation as to the size or shape thereof.

When the first object area is identical to the second object area, the derivation unit 140 may derive the motion information of the found neighboring block as the motion information for the current block.

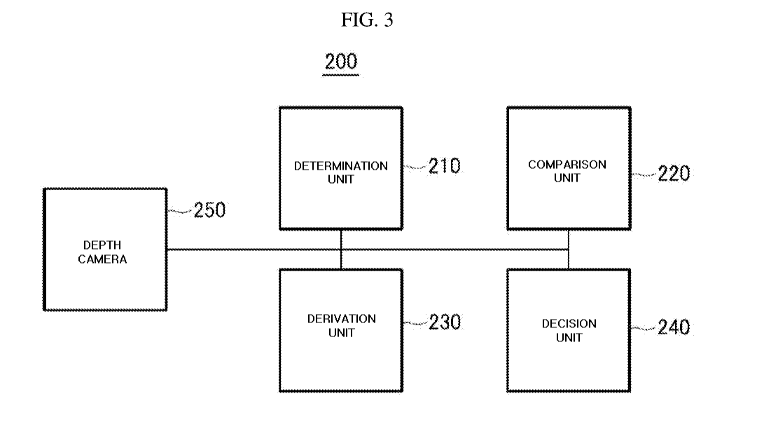

FIG. 3 is a block diagram of a video coding device according to another embodiment of the present invention.

Referring to FIG. 3, a video coding device 200 according to another embodiment of the present invention may include a determination unit 210, a comparison unit 220, a derivation unit 230, and a decision unit 240.

The video coding device 200 according to another embodiment of the present invention may be a video encoding/decoding device, and if it is a video decoding device, it may include the components illustrated in FIG. 1.

The determination unit 210 may determine whether motion information for a candidate neighboring block is present, the candidate neighboring block being configured as a motion merge candidate for the current block, among neighboring blocks which are spatially adjacent to the current block.

For example, if the candidate neighboring block is encoded through intra prediction, the determination unit 210 may determine that motion information for the candidate neighboring block is not present.

The candidate neighboring block may be a neighboring block located at the upper side of the current block and a neighboring block located at the left side of the current block.

When motion information for the candidate neighboring block is not present, the comparison unit 220 may compare a first object area, including a block within a reference image which temporally corresponds to the current block, with a second object area, including the candidate neighboring block, using depth information, and thereby determine whether the two object areas are the same.

A depth camera 250 for acquiring the depth information may be combined with or connected to the video coding device 200 as part of the same device, or may be arranged as a separate device. Also, with technological advances, it may be variously manufactured without limitation as to the size or shape thereof.

When the first object area is identical to the second object area, the derivation unit 230 may derive the motion information of the block within the reference image as the motion information for the candidate neighboring block.

The decision unit 240 may decide whether to include the motion information for the candidate neighboring block in the motion merge candidate for the current block according to the predetermined priority of the candidate neighboring block.

Also, when the determination unit 210 determines that motion information for the candidate neighboring block is present, the decision unit 240 may determine whether to include the motion information for the candidate neighboring block in the motion merge candidate for the current block according to the priority.

Additionally, when the first object area is found to differ from the second object area as the result of the comparison by the comparison unit 220, the decision unit 240 may exclude the motion information for the candidate neighboring block from the motion merge candidate for the current block.

If the above-mentioned video coding device proposed in the present invention is used, when video encoding/decoding procedures, including 3D video encoding/decoding procedures, are performed, even when the candidate neighboring block is encoded through an intra mode, motion information, inherited from the motion information of the block within the reference image, which is temporally co-located with the current block, may be used for encoding/decoding of the current block, thus improving the efficiency of coding of the current block.

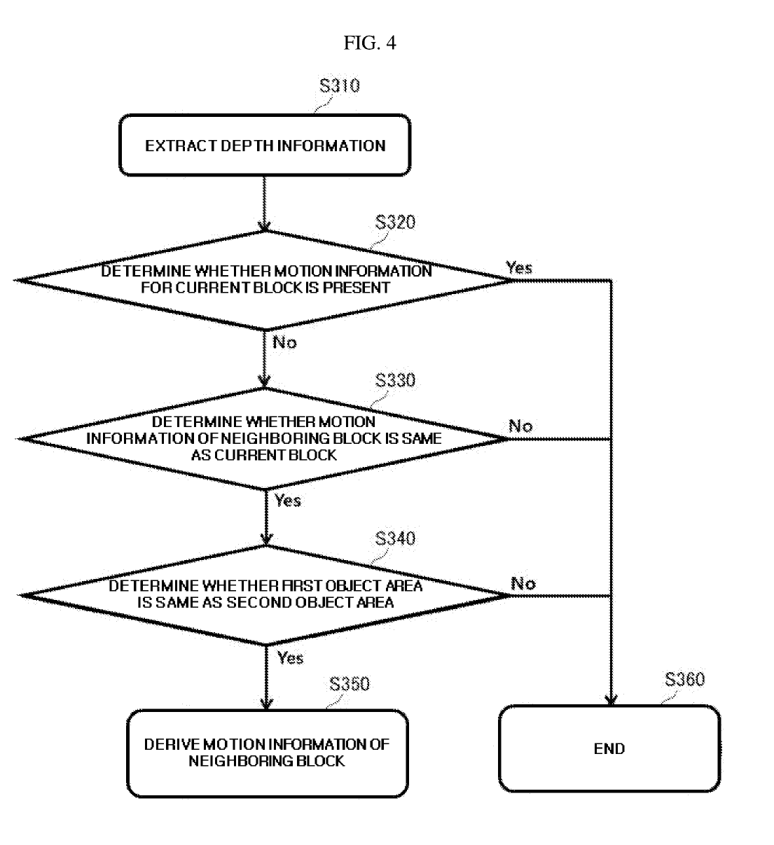

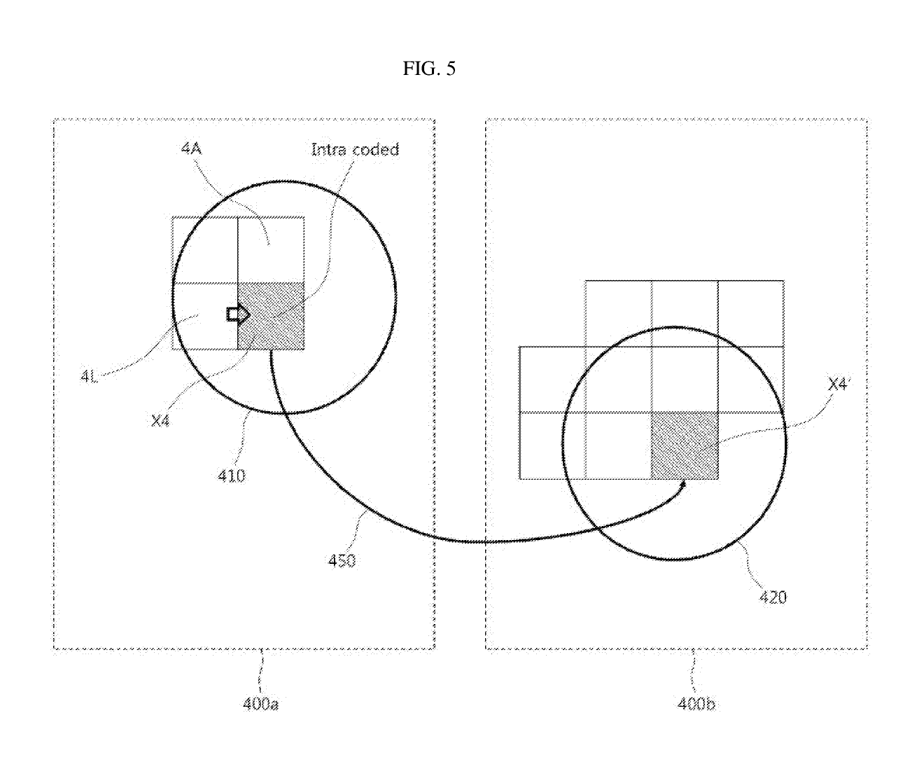

Meanwhile, a method for deriving motion information using depth information according to an embodiment of the present invention will be described in detail with reference to FIG. 4 and FIG. 5.

FIG. 4 is a flowchart of a method for deriving motion information using depth information according to an embodiment of the present invention, and FIG. 5 illustrates a method for deriving motion information using depth information according to an embodiment of the present invention.

Additionally, the method for deriving motion information using depth information according to an embodiment of the present invention may further include extracting depth information using a depth camera (S310).

Referring to FIG. 4 and FIG. 5, in the method for deriving motion information using depth information according to an embodiment of the present invention, first, whether motion information for the encoded current block X4 within the current image 400a is present is determined at step S320.

Then, if motion information for the current block X4 is not present, multiple neighboring blocks, which are spatially adjacent to the current block X4, are searched for a neighboring block having the same motion information as the current block at step S330 by comparing the motion information of the multiple neighboring blocks.

Then, whether a first object area 420, including the block X4′ within the reference image 400b, which temporally corresponds to the current block, is identical to a second object area 410, including the found neighboring blocks 4A and 4L, is determined through a comparison using depth information at step S340.

Here, the current block X4 within the current image 400a and the block X4′ within the reference image 400b has temporally correspondence relationship(co-located) each other, and this relationship may be described using a disparity vector 450.

Subsequently, when the first object area 420 is identical to the second object area 410, the motion information of the found neighboring blocks 4A and 4L is derived as the motion information for the current block X4 at step S350.

For example, the determining whether motion information is present for the encoded current block (S320) may be configured to determine that no motion information is present for the current block X4 if the current block X4 is encoded through intra prediction (intra-frame encoding).

Specifically, when the comparing (S340) is performed, labeling of the first object area 420 and labeling of the second object area 410 may be performed by analyzing depth information acquired using a depth camera. Also, based on the labeling, it may be compared about whether the first object area 420, including the block X4′ within the reference image 400b, which temporally corresponds to the current block X4 within the current image 400a, is identical to the second object area 410, including the found neighboring blocks 4A and 4L.

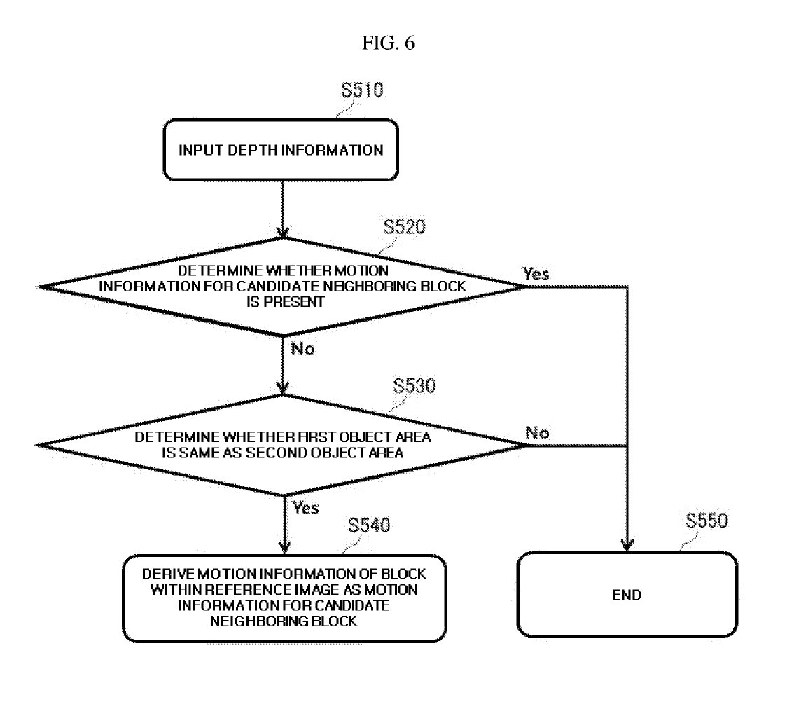

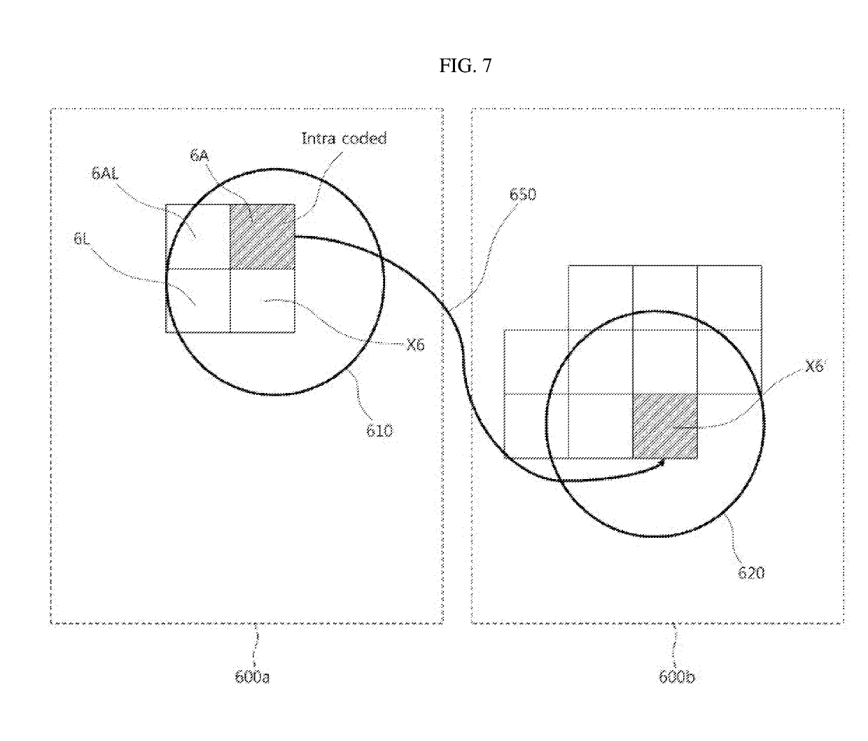

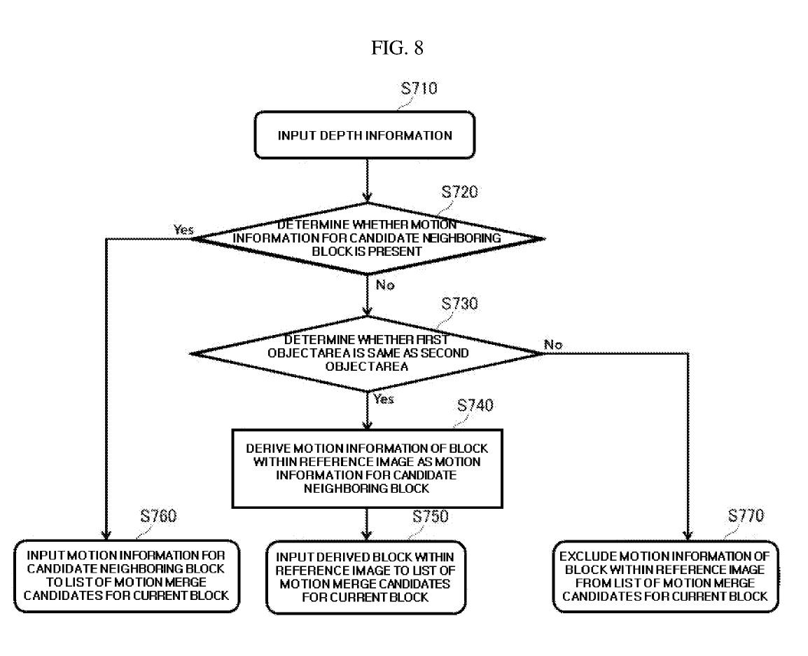

FIG. 6 is a flowchart of a method for deriving motion information using depth information according to another embodiment of the present invention, FIG. 7 illustrates a method for deriving motion information using depth information according to another embodiment of the present invention, and FIG. 8 is a flowchart of a method for deriving a motion merge candidate using depth information according to an embodiment of the present invention.

Additionally, the method for deriving motion information using depth information according to another embodiment of the present invention further includes acquiring depth information using a depth camera (S510).

Referring to FIG. 6 and FIG. 7, in the method for deriving motion information using depth information according to another embodiment of the present invention, whether motion information for a candidate neighboring block 6A is present may be determined at step S520, the candidate neighboring block 6A being configured as a motion merge candidate for the current block X6, among neighboring blocks, which are spatially adjacent to the current block X6 within the current image 600a.

Then, when no motion information for the candidate neighboring block 6A is present, whether a first object area 620, including the block X6′ within a reference image 600b, which is temporally co-located with the current block X6, is identical to a second object area 610, including the candidate neighboring block 6A, is determined through comparison using depth information at step S530.

Then, when the first object area 620 is identical to the second object area 610, the motion information of the block X6′ within the reference image 600b may be derived as the motion information for the candidate neighboring block 6A at step S540.

Here, in order to describe the method for deriving motion information using depth information according to another embodiment of the present invention, the above-mentioned candidate neighboring block 6A is described as the neighboring block 6A located above the current block X6, but the candidate neighboring block may include a neighboring block 6L located at the left side of the current block and a neighboring block 6AL located above and to the left of the current block.

For example, the determining whether there is motion information for the candidate neighboring block 6A, configured as a motion merge candidate for the current block X6, among neighboring blocks that are spatially adjacent to the current block X6 within the current image 600a (S520), may be configured to determine that no motion information is present for the candidate neighboring block 6A when the candidate neighboring block 6A is encoded through intra prediction.

Meanwhile, when no motion information is present for the candidate neighboring block 6A, the determining whether the first object area 620, including the block X6′ within the reference image 600b, which is temporally co-located with the current block X6, is identical to the second object area 610, including the candidate neighboring block 6A, through comparison using depth information (S530) includes performing labeling of the first object area 620 and labeling of the second object area 610 by analyzing depth information acquired using a depth camera, and the comparison may be performed based on the labeling.

Also, a method for deriving a motion merge candidate using depth information according to another embodiment of the present invention will be described in detail with reference to FIG. 7 and FIG. 8.

Referring to FIG. 7 and FIG. 8, the method for deriving a motion merge candidate using depth information according to another embodiment of the present invention includes determining whether there is motion information for a candidate neighboring block 6A, configured as a motion merge candidate for the current block X6, among neighboring blocks, which are spatially adjacent to the current block X6 within the current image 600a (S720); when no motion information is present for the candidate neighboring block 6A, determining whether the first object area 620, including the block X6′ within the reference image, which is temporally co-located with the current block X6, is identical to the second object area 610, including the candidate neighboring block 6A, through comparison using depth information (S730); when the first object area 620 is identical to the second object area 610, deriving the motion information of the block X6′ within the reference image 600b as the motion information for the candidate neighboring block 6A; and deciding whether to include the motion information for the candidate neighboring block 6A in the motion merge candidate for the current block X6, depending on the predetermined priority of the candidate neighboring block 6A.

Also, when motion information for the candidate neighboring block 6A is found to be present as the result of the determination of whether there is motion information for the candidate neighboring block 6A, configured as the motion merge candidate for the current block X6, among neighboring blocks, which are spatially adjacent to the current block X6 within the current image 600a, the above-mentioned method for deriving a motion merge candidate using depth information may further include deciding whether to include the motion information for the candidate neighboring block 6A in the motion merge candidate for the current block according to the priority.

Additionally, when no motion information is present for the candidate neighboring block 6A, if the first object area 620 is found to differ from the second object area 610 as the result of the determining whether the first object area 620, including the block X6′ within the reference image 600b, which is temporally co-located with the current block X6 within the current image 600a, is identical to the second object area 610, including the candidate neighboring block 6A, through comparison using depth information, excluding the motion information for the candidate neighboring block 6A from the motion merge candidate for the current block may be further included.

Here, in order to describe the method for deriving a motion merge candidate using depth information according to another embodiment of the present invention, the above-mentioned candidate neighboring block 6A is described as the neighboring block 6A located above the current block X6, but the candidate neighboring block may include the neighboring block 6L located at the left side of the current block and the neighboring block 6AL located above and to the left of the current block. The components included in embodiments of the present invention are not limited to software or hardware, and may be configured to be stored in addressable storage media and to execute on one or more processors.

Therefore, as an example, the components may include components such as software components, object-oriented software components, class components, and task components, processes, functions, attributes, procedures, subroutines, segments of program code, drivers, firmware, microcode, circuitry, data, databases, data structures, tables, arrays, and variables.

The components and functionality provided in the corresponding components may be combined into fewer components, or may be further separated into additional components.

The description of the present invention is intended for illustration, and those skilled in the art will appreciate that the present invention can be easily modified in other detailed forms without changing the technical spirit or essential features of the present invention. Therefore, the above-described embodiments should be understood as being exemplary rather than restrictive. For example, each component described as a single component may be distributed and practiced, and similarly, components described as being distributed may also be practiced in an integrated form.

The scope of the present invention should be defined by the accompanying claims rather than by the detailed description, and all changes or modifications derived from the meanings and scopes of the claims and equivalents thereof should be construed as being included in the scope of the present invention.

1. A method for deriving motion information using depth information, comprising:
searching multiple neighboring blocks for a neighboring block having the same motion information as an encoded current block by comparing motion information of the multiple neighboring blocks, which are spatially adjacent to the current block;
comparing a first object area, including a block within a reference image, which is temporally co-located with the current block, with a second object area, including the found neighboring block, using the depth information in order to determine whether the first object area is identical to the second object area; and
when the first object area is identical to the second object area, deriving the motion information of the found neighboring block as motion information for the current block.

2. The method of claim 1, further comprising
before the searching, determining whether motion information for the current block is present,
wherein the searching is performed when it is determined that motion information for the current block is not present as a result of the determining.

3. The method of claim 2, wherein the determining is configured to determine that motion information for the current block is not present when the current block is encoded through intra prediction.

4. The method of claim 1, wherein:
the comparing comprises performing labeling of the first object area and labeling of the second object area by analyzing depth information acquired using a depth camera, and
the comparing is performed based on the labeling.

5. A method for deriving motion information using depth information, comprising:
determining whether there is motion information for a candidate neighboring block, configured as a motion merge candidate for a current block, among neighboring blocks, which are spatially adjacent to the current block;
when motion information for the candidate neighboring block is not present, comparing a first object area, including a block within a reference image, which is temporally co-located with the current block, with a second object area, including the candidate neighboring block, using the depth information in order to determine whether the first object area is identical to the second object area; and
when the first object area is identical to the second object area, deriving motion information of the block within the reference image as the motion information for the candidate neighboring block.

6. The method of claim 5, wherein the determining is configured to determine that motion information for the candidate neighboring block is not present when the candidate neighboring block is encoded through intra prediction.

7. The method of claim 5, wherein the candidate neighboring block includes a neighboring block located at an upper side of the current block and a neighboring block located at a left side of the current block.

8. The method of claim 5, wherein:
the comparing comprises performing labeling of the first object area and labeling of the second object area by analyzing depth information acquired using a depth camera, and
the comparing is performed based on the labeling.

9. A method for deriving a motion merge candidate using depth information, comprising:
determining whether there is motion information for a candidate neighboring block, configured as a motion merge candidate for a current block, among neighboring blocks, which are spatially adjacent to the current block;
when motion information for the candidate neighboring block is not present, comparing a first object area, including a block within a reference image, which is temporally co-located with the current block, with a second object area, including the candidate neighboring block, using the depth information in order to determine whether the first object area is identical to the second object area;
when the first object area is identical to the second object area, deriving motion information of the block within the reference image as the motion information for the candidate neighboring block; and
deciding whether to include the motion information for the candidate neighboring block in the motion merge candidate for the current block according to a predetermined priority of the candidate neighboring block.

10. The method of claim 9, further comprising,
when the motion information for the candidate neighboring block is found to be present as a result of the determining, deciding whether to include the motion information for the candidate neighboring block in the motion merge candidate for the current block according to the priority.

11. The method of claim 9, further comprising,
when the first object area is found to differ from the second object area as a result of the comparing, excluding the motion information for the candidate neighboring block from the motion merge candidate for the current block.

12. A video coding device, comprising:
a search unit for searching multiple neighboring blocks for a neighboring block having the same motion information as an encoded current block by comparing motion information of the multiple neighboring blocks, which are spatially adjacent to the current block;
a comparison unit for comparing a first object area, including a block within a reference image, which is temporally co-located with the current block, with a second object area, including the found neighboring block, using depth information in order to determine whether the first object area is identical to the second object area; and
a derivation unit for deriving the motion information of the found neighboring block as motion information for the current block when the first object area is identical to the second object area.

13. The video coding device of claim 12, further comprising
a determination unit for determining whether motion information for the current block is present,
wherein the search unit searches for the neighboring block when motion information for the current block is not present.

14. The video coding device of claim 13, wherein the determination unit determines that motion information for the current block is not present when the current block is encoded through intra prediction.

15. A video coding device, comprising:
a determination unit for determining whether there is motion information for a candidate neighboring block, configured as a motion merge candidate for a current block, among neighboring blocks, which are spatially adjacent to the current block;
a comparison unit for comparing a first object area, including a block within a reference image, which is temporally co-located with the current block, with a second object area, including the candidate neighboring block, using depth information in order to determine whether the first object area is identical to the second object area when the motion information for the candidate neighboring block is not present; and
a derivation unit for deriving motion information of the block within the reference image as the motion information for the candidate neighboring block when the first object area is identical to the second object area.

16. The video coding device of claim 15, further comprising
a decision unit for deciding whether to include the motion information for the candidate neighboring block in the motion merge candidate for the current block according to a predetermined priority of the candidate neighboring block.

17. The video coding device of claim 15, wherein the determination unit determines that motion information for the candidate neighboring block is not present when the candidate neighboring block is encoded through intra prediction.

18. The video coding device of claim 15, wherein the candidate neighboring block includes a neighboring block located at an upper side of the current block and a neighboring block located at a left side of the current block.

19. The video coding device of claim 16, wherein when it is determined by the determination unit that motion information for the candidate neighboring block is present, the decision unit decides whether to include the motion information for the candidate neighboring block in the motion merge candidate for the current block according to the priority.

20. The video coding device of claim 16, wherein when the first object area is found to differ from the second object area as a result of comparison by the comparison unit, the decision unit excludes the motion information for the candidate neighboring block from the motion merge candidate for the current block.
